(19) United States
(12) Patent Application Publication
(10) Pub. No.: US 2007/0136193 A1
(43) Pub. Date: Jun. 14, 2007

(54) Methods, transactional cards, and systems using account identifers customized by the account holder

(75) Inventor: Robert Starr, Decatur, GA (US)

Correspondence Address: WITHERS & KEYS FOR BELL SOUTH, P. O. BOX 71355, MARIETTA, GA, 30007-1355, US

(73) Assignee: BellSouth Intellectual Property Corporation

(21) Appl. No.: 11/301,916

(22) Filed: Dec. 13, 2005

(51) Int. Cl. G06Q 40/00

(52) U.S. Cl. 705/41

(57) ABSTRACT

Account identifiers for accounts such as credit and debit accounts are customized by the account holder. The account identifiers may include both numerical and non-numerical characters. The account identifiers may include various combinations of letters and numbers and may include words or even phrases. The name of the account holder, the name of the bank associated with the account and associated card, words specifying the type of the account and card, arbitrary words chosen by the account holder, and others may be included in the account identifier. The account identifier is obtained during a transaction and is processed Such processing may include looking up the account identifier in a financial database that associates financial information of the account holder with the account identifier or by looking up the account identifier in a database that associates the account identifier to a standard numerical account number.

### TECHNICAL FIELD

The present invention is related to transactions involving accounts such as credit and debit accounts. More particularly, the present invention is related to transactions that involve accounts having account identifiers that have been customized by the account holder.

### BACKGROUND

Transactions involving accounts, such as credit and/or debit accounts, require an account number. Typically, the account number is provided on a transactional card, both visibly and by encoding upon a magnetic strip. The account number is used during the transaction to determine whether a monetary amount associated with the account number is sufficient relative to the monetary amount involved in the transaction, and once the transaction is closed, the transaction is recorded in association with the account number to establish a record of the transaction.

Conventionally, the account number is a fixed number of Arabic numerals. The number has varied from 13 digits to 16 digits. While the number has significance in that each account holder has a unique number assigned to the account, the unique number is otherwise arbitrary from the perspective of the account holder. As a result, most account holders cannot easily remember the account number and the account number has no significance or appeal from the perspective of the account holder.

### SUMMARY

Embodiments of the present invention address these and other issues by providing account identifiers that are customized by the account holder so that the account holder can have a more meaningful account identifier. The account identifier may be processed similar to the standard account number of a conventional transactional account such as by storing the financial information of the account holder in relation to the account identifier in a transactional database. As an alternative, the account identifier may be related to a standard account number in a translational database that converts the account identifier to the standard account number for purposes of finding financial information in a transactional database indexed by standard account numbers.

One embodiment is a transactional card that includes a sheet of material and an account identifier visible on a side of the sheet of material, wherein the account identifier has been customized by the account holder. The transactional card further includes a machine readable encoded area having the account identifier that has been customized by the account holder encoded thereon.

Another embodiment is a transactional processing system that includes a transactional input device that receives an account identifier that has been customized by the account holder. The transactional processing system further includes a network that is in communication with the transactional input device and that transfers the account identifier that has been customized by the account holder. A database is in communication with the network and relates account information to the account identifier that has been customized by the account holder, and wherein the database receives a query for the account identifier received through the network and returns the account information in response to the query.

Another embodiment is a method of providing for customized account numbers for transactional accounts. The method involves receiving a customized account identifier from an account holder and associating the customized account identifier with account information that is located within a transactional database. The method further involves, or a transaction, obtaining the account identifier that has been customized by the account holder, and finding account information relevant to the transaction by looking up the account identifier in the transactional database.

### DESCRIPTION OF THE DRAWINGS

FIG. 1 shows a view of a front side of one example of a transactional card having a visible account identifier that has been customized by the account holder.

FIG. 2 shows a view of a back side of the transactional card of FIG. 1 having a machine readable strip.

FIG. 3 shows one example of a transactional processing system that utilizes the account identifier that has been customized by the account holder to find account information relevant to a transaction.

FIG. 4 shows another example of a transactional processing system that utilizes the account identifier that has been customized by the account holder to find an account number and related account information relevant to a transaction.

### DETAILED DESCRIPTION

Embodiments of the present invention provide for transactional accounts that have account identifiers that have been customized by the account holder rather than being arbitrarily assigned by the account issuer. The customized account identifier may include non-numerical characters including letters and symbols and may form words or phrases that the account holder has chosen to create vanity account identifiers. These account identifiers may be used to look up account information needed for a transaction and/or to find standard account numbers associated with the account identifier. Furthermore, these account identifiers may be included on a transactional card for each account, both visibly and encoded on a machine readable strip.

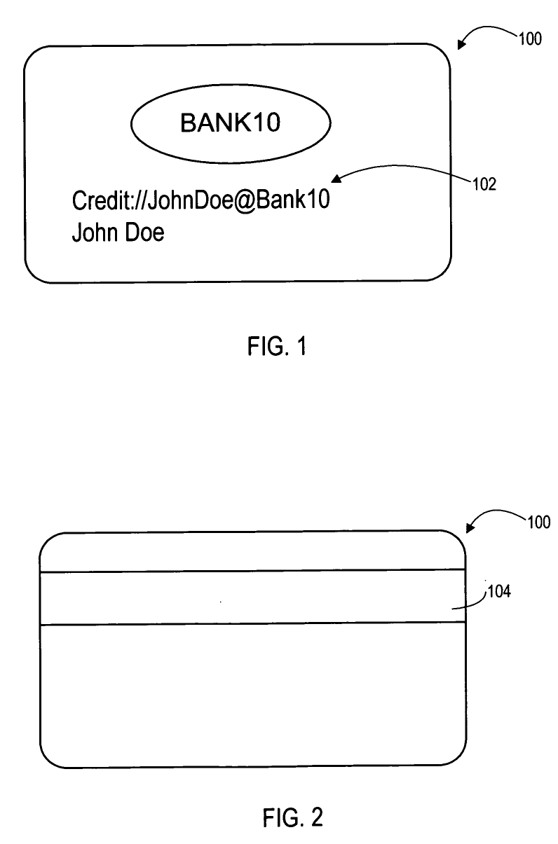

FIG. 1 shows an example of such a transactional card 100. The transactional card 100 may be a conventional transactional card, such as a credit or debit card, but the transactional card 100 has an account identifier 102 that includes alphabetical characters rather than only including numbers. The transactional card 100 may be manufactured according to well known techniques and using well known materials for producing transactional cards. For example, the transactional card 100 may be constructed of plastic.

When the account holder wishes to open the account, the account holder may be given the option at that time to customize the account identifier rather than being assigned one arbitrarily. The account holder may then submit the account identifier as an additional piece of information to the account issuer. The account issuer may then open the account in association with the account identifier if the account identifier meets the criteria required by the account issuer. For example, the criteria might include that the account identifier be unique relative to all other account identifiers currently in existence, a minimum number of characters, and any specific words, phrases, symbols, or numerals.

In the example shown, the account identifier 102 of the transactional card 100 that has been customized by the account holder is: “credit://JohnDoe@Bank 10,” and it can be seen that it includes both numerical and non-numerical characters and symbols. In this example, the account issuer has included in this particular account identifier the word “credit” to specify that the transactional account is a credit account. To customize the account identifier, the account holder has chosen to use his name, “John Doe,” and has chosen to include the name of the bank “Bank10” that is associated with the transactional account.

It will be appreciated that the account identifier 102 may be of a wide variety of formats in addition to the one shown. The customized account identifier that is chosen by the account holder may be words or phrases. The account identifier may include words setting forth the type of account such as credit or debit or may not. The account identifier may include words setting forth the name of the account holder and/or bank or may not. The scheme used for choosing or otherwise assigning account identifiers that may include both numerical and non-numerical characters may be as flexible or as rigid as desired by the parties involved in the transaction processing so long as the account identifiers continue to uniquely identify the account of the account holder.

FIG. 2 shows the back side of the transactional card 100. The back side may be conventional in nature except that the back side may include a machine readable strip 104, such as a magnetic strip or a bar code. The machine readable strip 104 has encoded upon it the account identifier 102. The encoding may be through conventional techniques. Each individual character of the account identifier may be represented through one of many coding techniques capable of supporting non-numerical characters including letters and/or symbols in addition to numbers, such as the American Standard Code for Information Interchange (ASCII) or Extended Binary Coded Decimal Interchange Code (EBCDIC) schemes. For example, the account identifier may be based on a 7 bit or 8 bit International Alphabet 5/ASCII characters, Unicode 16 bit characters, or other schemes such as to include foreign language symbols, Greek symbols, mathematical symbols, and the like. Furthermore, such encoding may be used in conjunction with existing standards for transactional card information exchange including ISO 8583 to facilitate the transfer of the account identifier.

Details on various encoding schemes, standards for data exchange in financial transactions, and standards for data transfer via non-ASCII character sets may be applicable to one or more embodiments discussed herein. Such details can be found from the following technical references, each of which is incorporated herein by reference.

These technical references include:

1. http://www.iso.org/iso/en/CombinedQueryResult.CombinedQueryResult?queryString=8583
2. ISO 8583-1:2003 Ed. 1—Financial transaction card originated messages—Interchange message specifications—Part 1: Messages, data elements and code values
3. ISO 8583-2:1998 Ed. 1—Financial transaction card originated messages—Interchange message specifications—Part 2: Application and registration procedures for Institution Identification Codes (IIC)
4. ISO 8583-3:2003 Ed. 2—Financial transaction card originated messages—Interchange message specifications—Part 3: Maintenance procedures for messages, data elements and code values
5. http://www.ietf.org—Internet Request for Comments (RFCs)
6. RFC3986—Uniform Resource Identifier (URI): Generic Syntax
7. RFC3987—Internationalized Resource Identifiers (IRIs)

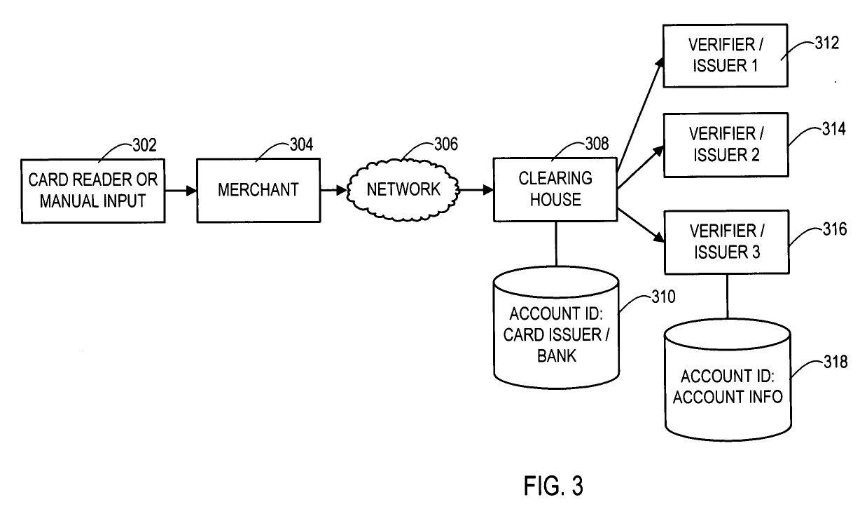

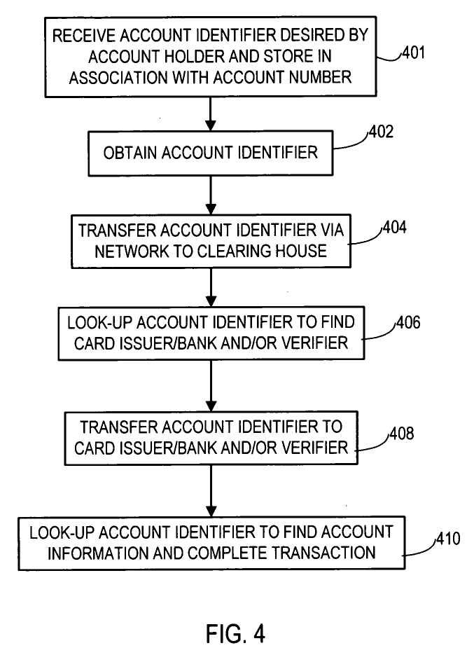

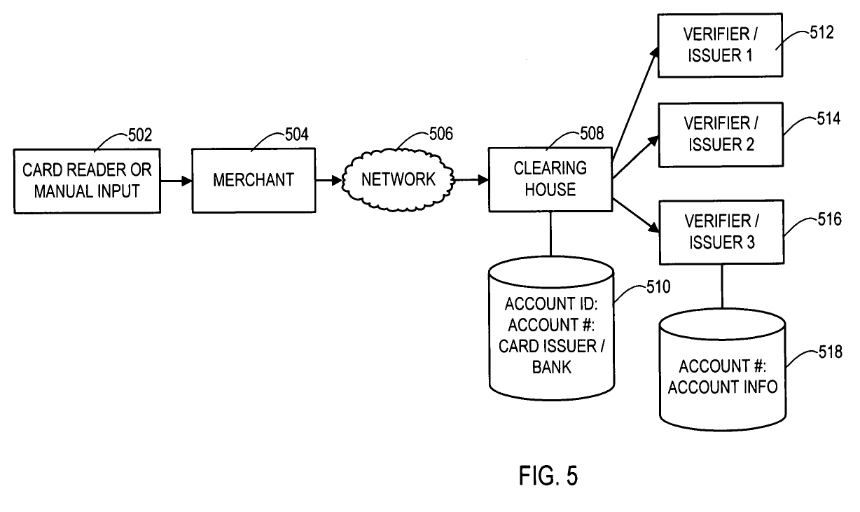

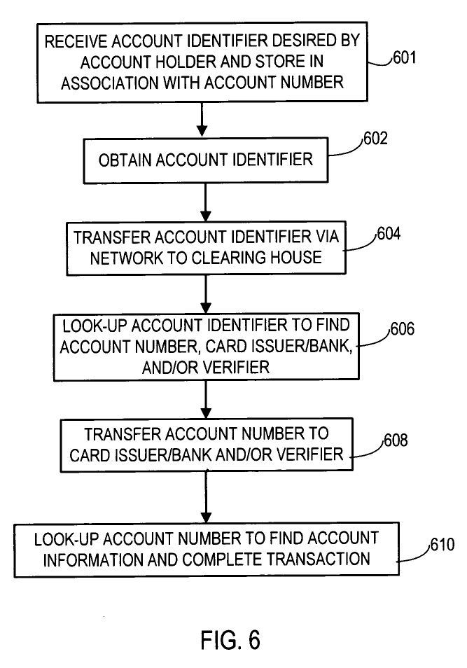

FIG. 3 shows one example of a transaction processing system that processes the customized account identifier for a particular transaction and FIG. 4 shows an operational flow that may be performed by the transaction processing system of FIG. 3. Initially, the account is created by receiving the desired customized account identifier from the account holder. If the customized account identifier meets the criteria for approval including uniqueness relative to other account identifiers, then the customized account identifier is associated with account information in a transactional database at account operation 401. The customized account identifier is obtained during a subsequent transaction by an input device such as a card reader 302 or a keyboard for manual entry at input operation 402. The input device 302 is present at the point of sale for the transaction and includes well known devices such as magnetic card readers. The input device 302 is utilized by the merchant organization 304 through which the transaction is occurring.

The merchant organization 304 maintains a data connection for the input device 302 to a telecommunications network 306. In this example, the customized account identifiers are transferred from the input device 302 through the network 306 to a remote location known as a clearing house 308 at transfer operation 404. The clearing house 308 serves to route the customized account identifiers to the particular account verifier (e.g., VISA, MasterCard) or card issuer and/or bank 312, 314, 316 that is necessary to complete the particular transaction.

To accomplish the routing of the customized account identifiers to the appropriate destination for purposes of completing the transaction, the clearing house 308 accesses a database 310 that associates customized account identifiers to the network address(es) of the verifier or card issuer and/or bank 312, 314, 316 and looks up the customized account identifier at look-up operation 406. Thus, as opposed to a conventional clearing house database that relates exclusively numerical account numbers to the network addresses of the verifier or card issuer and/or bank 312, 314, 316, the clearing house database 310 includes the customized account identifiers instead. Additionally, the clearing house 308 forwards the customized account identifier on to the destination 312, 314, 316 as opposed to forwarding the exclusively numerical account number at transfer operation 408.

Once the destination 312, 314, 316 has the customized account identifier for the transaction, the destination may then access its own database 318 to find the necessary account information associated with the account identifier by looking up the customized account identifier at look-up operation 410. So, rather than database 318 associating an exclusively numerical account number with the account information of interest for a transaction, the database 318 associates the customized account identifier with the account information. Account information may include such things as verification information like extra security digits for the card that are not encoded on the machine readable strip but must be manually entered, financial information such as a monetary amount remaining in a debit account or a monetary amount remaining in a credit account. The destination 312, 314, 316 upon finding the appropriate account information may then return a response to the input device 302 of the merchant 304 to complete the transaction, such as by approving or denying the attempted transaction.

FIG. 5 shows another example of a transaction processing system that processes the customized account identifier for a particular transaction, and FIG. 6 shows an operational flow that may be performed by the transaction processing system of FIG. 5. Initially, the account is created by receiving the desired customized account identifier from the account holder. If the customized account identifier meets the criteria for approval including uniqueness relative to other account identifiers, then the customized account identifier is associated with a standard account number in a translational database at account operation 601. As with the system of FIG. 3, the customized account identifier is then obtained during a subsequent transaction by an input device such as a card reader 502 or a keyboard for manual entry at input operation 602.

The merchant organization 504 maintains a data connection for the input device 502 to a telecommunications network 506. In this example, the customized account identifiers are transferred from the input device 502 through the network 506 to a clearing house 508 at transfer operation 604. The clearing house 508 routes the customized account identifiers to the particular account verifier, or card issuer, and/or bank 512, 514, 516 that completes the particular transaction.

To accomplish the routing of the customized account identifiers to the appropriate destination for purposes of completing the transaction, the clearing house 508 accesses a database 510 that associates customized account identifiers to standard account numbers that are exclusively numerical. The database 510 further associates the customized account identifier to the network address(es) of the verifier, or card issuer, and/or bank 512, 514, 516 and looks up the customized account identifier at look-up operation 606. Then, rather than forwarding the customized account identifier, the clearing house 508 forwards the standard account number associated with the customized account identifier on to the destination 512, 514, 516 at transfer operation 608.

Once the destination 512, 514, 516 has the account number for the transaction, the destination may then access its own database 518 to find the necessary account information associated with the account number by looking up the account number at look-up operation 610. So, database 518 as well as destination 512, 514, 516 may operate entirely in the conventional manner to obtain the account information and respond accordingly to complete the transaction.

This example of FIGS. 5 and 6 demonstrate that the clearing house can translate from the customized account identifier to the underlying account number so that the destinations from the clearing house may operate in the conventional manner to complete the transaction. In this way, the database 510 is functioning much like a domain name server (DNS) of the Internet to translate from an alphanumerical string to a purely numerical address format. The application of DNS standards including security considerations and the use of non-ASCII characters in domain names may be applicable to one or more embodiments discussed herein where the customized account identifier is comparable to a domain name. Accordingly, the following technical documents regarding DNS implementations are incorporated herein by reference. The documents include:
1. RFC1034—Domain names—concepts and facilities
2. RFC1035—Domain names—implementation and specification
3. RFC2065—Domain Name System Security Extensions
4. RFC2219—Use of DNS Aliases for Network Services
5. RFC2230—Key Exchange Delegation Record for the DNS
6. RFC2535—Domain Name System Security Extensions
7. RFC2536—DSA KEYs and SIGs in the Domain Name System (DNS)
8. RFC2537—RSA/MD5 KEYs and SIGs in the Domain Name System (DNS)
9. RFC2538—Storing Certificates in the Domain Name System (DNS)
10. RFC2539—Storage of Diffie-Hellman Keys in the Domain Name System (DNS)
11. RFC2541—DNS Security Operational Considerations
12. RFC2845—Secret Key Transaction Authentication for DNS (TSIG)
13. RFC2930—Secret Key Establishment for DNS (TKEY RR)
14. RFC2931—DNS Request and Transaction Signatures (SIG(0)s)
15. RFC3110—RSA/SHA-1 SIGs and RSA KEYs in the Domain Name System (DNS)
16. RFC3445—Limiting the Scope of the KEY Resource Record (RR)
17. RFC3467—Role of the Domain Name System (DNS)
18. RFC3645—Generic Security Service Algorithm for Secret Key Transaction Authentication for DNS (GSS-TSIG)
19. RFC4033—DNS Security Introduction and Requirements
20. RFC4034—Resource Records for the DNS Security Extensions
21. RFC4035—Protocol Modifications for the DNS Security Extensions
22. RFC4185—National and Local Characters for DNS Top Level Domain (TLD) Names

It will be appreciated that the database for translating the customized account identifier to the standard account number may be located elsewhere, such as at the location of the merchant 504. In this scenario, the merchant 504 performs the translation from the account identifier to the standard account number and then transfers the account number to the clearing house. In this scenario, the transfer to the clearing house, and the clearing house itself may operate entirely in the conventional manner for processing transactions.

Because the customized account identifier may include words or phrases including the name of the account holder, the account identifier becomes much easier to memorize. While this may be beneficial to the account holder, such as eliminating the need to carry a transactional card to represent the account in some cases, it also results in those with malicious intent being able to more easily misappropriate the customized account identifier. Therefore, it may be desirable to include some additional security features for the transactional account such as requiring entry of a personal identification number (PIN) memorized by the account holder, a voice or fingerprint scan of the account holder, a security code included on the transactional card but not on the machine readable strip, etc. Such information may then be used by the verifier to confirm that the attempted user of the customized account identifier is indeed the account holder.

The discussion above has focused on allowing the account holder to customize the account identifier or portions thereof. In doing so, both non-numerical and numerical characters have been made available for selection when selecting the customized account identifier, and the ability to process a transactional account with such an account identifier has been established. Accordingly, even for scenarios where the account holder is not given the opportunity to customize the account identifier, it will be appreciated that the account identifier that is assigned to the account holder may include non-numerical characters rather than or in addition to numerical ones and the same transactional processing still applies.

While the invention has been particularly shown and described with reference to various embodiments thereof, it will be understood by those skilled in the art that various other changes in the form and details may be made therein without departing from the spirit and scope of the invention.

What is claimed is:

1. A transactional card, comprising:
a sheet of material;
an account identifier visible on a side of the sheet of material, wherein the account identifier has been customized by the account holder; and
a machine readable encoded area having the account identifier that has been customized by the account holder encoded thereon.

2. The transactional card of claim 1, wherein the account identifier includes numerical and non-numerical characters.

3. The transactional card of claim 2, wherein the account identifier includes words.

4. The transactional card of claim 3, wherein the account identifier includes an indication that the transactional card is for a credit account.

5. The transactional card of claim 3, wherein the account identifier includes an indication that the transactional card is for a debit account.

6. The transactional card of claim 3, wherein the account identifier includes an indication of a bank that is associated with the transactional card.

7. The transactional card of claim 3, wherein the words include a name of the card holder.

8. The transactional card of claim 1, wherein the encoded area comprises a magnetic strip having magnetically encoded thereon the account identifier that has been customized by the account holder.

9. The transactional card of claim 1, wherein the account identifier is encoded as ASCII character values.

10. A transactional processing system, comprising:
a transactional input device that receives an account identifier that has been customized by the account holder;
a network that is in communication with the transactional input device and that transfers the account identifier that has been customized by the account holder; and
a database that is in communication with the network and that relates account information to the account identifier that has been customized by the account holder, and wherein the database receives a query for the account identifier received through the network and returns the account information in response to the query.

11. The transactional processing system of claim 10, wherein the account identifier includes words.

12. The transactional processing system of claim 10, wherein the words include an indication of the type of transactional account and wherein the type of transactional account is one of credit and debit.

13. The transactional processing system of claim 11, wherein the words include an indication of a bank that is associated with the transactional account and wherein the account identifier is routed within the network to the database according to the indication of the bank.

14. The transactional processing system of claim 10, wherein the transactional input device comprises a card reader that reads a strip of a transactional card to obtain the account identifier that is encoded on the strip of the transactional card.

15. The transactional processing system, of claim 10 wherein the account information of the database is an exclusively numerical account number associated with the account identifier and wherein the account number includes non-numerical characters.

16. The transactional processing system of claim 15, further comprising a second database that associates financial information with the exclusively numerical account number.

17. A method of providing for customized account numbers for transactional accounts, comprising:
receiving a customized account identifier from an account holder;
associating the customized account identifier with account information that is located within a transactional database;
for a transaction, obtaining the account identifier that has been customized by the account holder; and
finding account information relevant to the transaction by looking up the account identifier in the transactional database.

18. The method of claim 17, wherein the account information comprises at least one of a monetary amount of remaining credit and a monetary amount remaining in a debit account.

19. The method of claim 17, wherein obtaining the account identifier comprises reading a machine readable strip of a transactional card where the machine readable strip has the account identifier encoded thereon.

20. The method of claim 17, wherein the account information comprises an exclusively numerical account number associated with the account identifier, the method further comprising finding additional account information by looking up the exclusively numerical account number in a second database that associates the exclusively numerical account number with the additional account information.
